(19) United States
(12) Patent Application Publication
(10) Pub. No.: US 2022/0290074 A1
(43) Pub. Date: Sep. 15, 2022

(54) DETERGENT COMPOSITION FOR DISSOLVING A MINERAL DEPOSIT

(71) Applicant: DeLaval Holding AB, Tumba (SE)

(72) Inventor: Reed Semenza, Copperopolis, CA (US)

(21) Appl. No.: 17/635,186

(22) PCT Filed: Jul. 22, 2020
(86) PCT No.: PCT/SE2020/050743

§ 371 Date: Feb. 14, 2022

(30) Foreign Application Priority Data
Aug. 15, 2019 (SE) 1950937-1

(51) Int. Cl. C11D 3/04; C11D 11/00; C11D 3/06; C11D 3/34; C11D 17/00

(52) U.S. Cl. CPC C11D 3/042; C11D 11/0041; C11D 3/06; C11D 3/3409; C11D 17/0008

(57) ABSTRACT

Compositions for rapidly dissolving mineral deposits on the surface of an apparatus, particularly a food or beverage-handling clean-in-place (CIP) apparatus, and methods of using the same are provided. In particular, the compositions are effective in removing magnesium phosphate deposits and comprise at least two mineral acids, with one of the mineral acids being nitric acid, and at least one nonionic surfactant.

### BACKGROUND OF THE INVENTION

### Field of the Invention

The present invention is generally directed toward compositions for dissolving a mineral deposit on the surface of an apparatus, particularly a food or beverage-handling clean-in-place (CIP) apparatus, and methods of using the same. The compositions are particularly suited for rapidly dissolving magnesium phosphate deposits and comprise at least two mineral acids, with one of the mineral acids being nitric acid, and at least one nonionic surfactant.

### Description of the Prior Art

Magnesium phosphate is a common and difficult to remove compound that forms as a result of supersaturation of magnesium phosphate in mix tanks that are used to produce, for example, certain high-protein drinks. Traditionally, nitric acid has been used to remove magnesium phosphate scale; however, when the magnesium phosphate deposits are highly crystalline in nature, the time to clean (>12 hours) and the concentration of nitric acid required (>5%) make the cleaning process uneconomical. Therefore, a need exists for a composition for and method of removing magnesium phosphate deposits from clean-in-place apparatus much more rapidly than the conventional process.

### SUMMARY OF THE INVENTION

According to one embodiment of the present invention there is provided a method of dissolving a mineral deposit on at least one surface of a clean-in-place apparatus. The method comprises introducing into the clean-in-place system an aqueous detergent composition comprising nitric acid, at least one mineral acid other than nitric acid, and at least one non-ionic surfactant. The at least one surface of the clean-in-place apparatus comprising the mineral deposit is contacted with the detergent composition and the mineral deposit is dissolved. During the contacting step, the temperature of the detergent composition is from 30-95° C.

According to another embodiment of the present invention there is provided a detergent composition comprising from about 1-40% by weight of nitric acid, from about 0.5-25% by weight of the at least one mineral acid other than nitric acid, from about 0.05-10% by weight of the at least one nonionic surfactant, and from about 0-5% by weight of an alkyl sulfonic acid. These compositions can be provided in the form of concentrates that may be diluted to form a use solution, or the compositions can be provided in ready-to -use form, which do not require further dilution.

According to yet another embodiment of the present invention there is provided a detergent use solution comprising from about 0.1-10% by weight of nitric acid, from about 0.01-5% by weight of the at least one mineral acid other than nitric acid, from about 0.005-2.5% by weight of the at least one nonionic surfactant, and from about 0-2.5% by weight of an alkyl sulfonic acid. The use solution is preferably prepared by diluting a concentrated detergent composition as described herein.

### DETAILED DESCRIPTION OF THE PREFERRED EMBODIMENT

In certain embodiments, the present invention is directed toward detergent compositions comprising a blend of at least two mineral acids, and a non-ionic surfactant. It was discovered that the compositions of the present invention produce a synergistic effect when used to remove mineral deposits from the surfaces of clean-in-place equipment, particularly when used at a relatively low concentration.

The detergent compositions comprise nitric acid, at least one other mineral (or inorganic) acid other than nitric acid, and at least one nonionic surfactant. In certain embodiments, the at least one other mineral acid is selected from the group consisting of sulfuric acid, hydrochloric acid, perchloric acid, boric acid, phosphoric acid, hydrofluoric acid, hydrobromic acid, hydroiodic acid, and combinations thereof, with phosphoric acid being particularly preferred. The at least one non-ionic surfactant preferably comprises, consists of, or consists essentially of an alkyl alkoxylated alcohol or ether. Preferred nonionic surfactants include capped or uncapped poly-lower alkoxylated higher alcohols or ether derivatives thereof, in which the alcohol or ether contains 9 to 18 carbon atoms and the number of moles of lower alkylene oxide (2 to 4 carbon atoms) is from 3 to 12. Exemplary alkyl alkoxylated alcohols or ethers suitable for use with the present invention include the water soluble or dispersible nonionic surfactants from BASF under the name Plurafac® (Fatty alcohol alkoxylates), and Lutenol® (fatty alcohol ethoxylates). These surfactants generally comprise the reaction product of a higher linear alcohol and a mixture of at least two of butylene, propylene, and ethylene oxides.

Preferred Plurafac® surfactants include Plurafac® LF-303 (polyglycol ether), Plurafac® LF-305 (C8-C14 alkyl chain), Plurafac® S-305LF, Plurafac® SLF-18B (C6-C10 ethoxylated linear alcohol), Plurafac® SLF-18B45, Plurafac® LF-4030, and Plurafac® LF-220 (C13-C15 branched and linear butoxylated ethoxylated alcohol). Other exemplary nonionic surfactants include those by Shell Chemical Company under the name Neodol®.

These surfactants are condensation products of a mixture of higher fatty alcohols averaging about 12 to 15 carbon atoms with about 6-7 moles of ethylene oxide. Yet additional exemplary nonionic surfactants include those from Union Carbide under the names Tergitol® and Triton®, and the low foaming, biodegradable alkoxylated linear fatty alcohols by BASF under the name Poly-Tergent®.

The detergent compositions may further comprise, consist of, or consist essentially of additional, optional components. One such additional component is a lower-alkyl (C1-C6) sulfonic acid, such as methane sulfonic acid. Another optional component is a corrosion inhibitor, such as urea, which may be present in the concentrated detergent formulations at a level of from about 0-2.5% by weight, about 0.001-1% by weight, or about 0.01-0.5% by weight, or in use solutions at a level of from about 0-1% by weight, about 0.0001-0.1% by weight, or about 0.0005-0.01% by weight. Yet a further optional component is one or more defoaming surfactants.

In those applications in which excessive foaming is to be avoided (i.e., CIP systems) an anti-foaming agent or defoamer can be used to reduce the formation of foam and/or break down the produced foam quickly. Preferred defoaming agents includes compounds produced by the condensation of a hydrophilic alkylene oxide group with an aliphatic or alkyl aromatic hydrophobic compound. Exemplary defoaming agents include polyethylene oxide condensates of alcohols or alkyl phenols (e.g., the condensation products of alcohol or alkyl phenols having an alkyl group containing from about 5 to about 15 carbon atoms in a straight chain or branch chain configuration) with ethylene oxide. The ethylene oxide is preferably present in amounts from about 10-60 moles of ethylene oxide per mole of alcohol or alkyl phenol. The alkyl substituents in such compounds may be derived from polymerized propylene, butylenes, isobutylene, and diisobutylene.

Exemplary preferred defoaming agents include various nonionic surfactants sold under name DEGRESSAL (e.g., DEGRESSAL SD20), PLURAFAC (e.g., PLURAFAC SLF-180), and HEDIPIN (e.g., HEDIPIN-AFT/100). DEHYPON, SYNPERONIC, and DOWFAX. The defoaming agent may be present in concentrated forms of the detergent composition at a level of from about 0.01-2% by weight, from about 0.05-1% by weight or from about 0.1-0.5% by weight. The defoaming agent may be present in use solution forms of the detergent composition at a level of from about 0.001-0.2% by weight, from about 0.005-0.1% by weight, or from about 0.01-0.05% by weight.

Detergent concentrates according to certain embodiments of the present invention may have a pH of from 0.5-4, from 1-3, or from 1.5-2.

Tables 1 and 2 list exemplary detergent concentrate and use solution formulations according to preferred embodiments of the present invention. As used herein, a “use solution” is a diluted form of a concentrate that once prepared is suitable for use in cleaning, for example, clean-in-place equipment. The nonionic surfactant may comprise any of those described above, such one or more alkoxylated alcohols, such as Plurafac® LF-220.

TABLE 1
Exemplary Detergent Concentrate Formulations

| | Broad range | Intermediate | Narrow |
|---|---|---|---|
| Component | (wt. %) | range (wt. %) | range (wt. %) |
| Nitric acid | 1-40% | 5-35% | 10-30% |
| Other mineral acid (e.g., | 0.5-25% | 1-20% | 5-15% |
| phosphoric acid) | | | |
| Alkylsulfonic acid (e.g., | 0-5% | 0.01-3% | 0.1-1% |
| methanesulfonic acid) | | | |
| Nonionic surfactant | 0.05-10% | 0.1-5% | 0.5-2.5% |
| Water | 35-90% | 45-85% | 55-80% |

TABLE 2
Exemplary Use Solution Formulations

| | Broad range | Intermediate | Narrow |
|---|---|---|---|
| Component | (wt. %) | range (wt. %) | range (wt. %) |
| Nitric acid | 0.1-10% | 0.5-5% | 1-2.5% |
| Other mineral acid | 0.01-5% | 0.05-2.5% | 0.1-1% |
| (e.g., phosphoric acid) | | | |
| Alkylsulfonic acid | 0-2.5% | 0.001-1% | 0.01-0.5% |
| (e.g., methanesulfonic | | | |
| acid) | | | |
| Nonionic surfactant | 0.005-2.5% | 0.01-1% | 0.02-0.5% |
| Water | 80-99.5% | 90-99% | 95-98% |

In certain embodiments of the present invention, a synergistic effect in dissolving mineral deposits, especially mineral deposits that predominantly comprise magnesium phosphate, is observed when the weight ratio of nitric acid to the at least one mineral acid other than nitric acid is from about 3:1 to 20:1, from about 6:1 to 17:1, or from about 9:1 to 15:1. Other mineral deposits that may be dissolved using compositions according to the present invention include those that comprise or predominantly comprise calcium phosphate, calcium sulfate, magnesium sulfate, barium sulfate, chromium phosphate, chromium sulfate, zinc phosphate, and zinc sulfate.

In certain embodiments, the weight ratio between the nitric acid and the at least one nonionic surfactant is from about 20:1 to 150:1, from about 50:1 to 120:1, or from about 70:1 to 100:1.

In certain embodiments, the weight ratio between the at least one mineral acid other than nitric acid to the at least one nonionic surfactant is from about 1:1 to 20:1, from about 2.5:1 to 14:1, or from 4:1 to 8:1.

The compositions described above are particularly suited for use in dissolving mineral deposits, especially mineral deposits on at least one surface of a clean-in-place (CIP) apparatus. As used herein, the term “clean-in-place apparatus” refers to apparatus that is configured to be cleaned without disassembly of all parts making up the apparatus. In particular, this includes pipes, vessels, process equipment, filters, associated fittings, and the like. Particularly preferred CIP equipment is that which is used in the dairy, beverage, brewing, food-processing, and/or pharmaceutical industries. Generally, cleaning is accomplished within CIP equipment by circulating an aqueous detergent solution through the equipment so as to contact all soiled surfaces of the equipment.

In one embodiment, the method comprises the step of introducing into the clean-in-place system an aqueous detergent composition as described herein. Preferably the detergent composition comprises nitric acid, at least one mineral acid other than nitric acid, at least one non-ionic surfactant. As indicated previously, the detergent compositions are particularly effective in removing mineral deposits, such as magnesium phosphate, from the surfaces of the equipment. Therefore, in preferred embodiments, the equipment to be cleaned will comprise surfaces containing mineral deposits, preferably magnesium phosphate deposits. The mineral deposits may be in the form of a thin layer of scale that coats a portion of the surfaces of the equipment. However, the detergent compositions are also particularly effective in dissolving highly crystalline deposits, with less total surface area than scale, generally.

The method further comprises contacting the at least one surface of the clean-in-place apparatus that comprises the mineral deposit with the detergent composition and dissolving the mineral deposit. During the contacting step it is preferred that the detergent composition has a temperature of less than 95° C., less than 75° C., or less than 65° C. Alternatively, the temperature of the detergent composition during the contacting step is from about 30-95° C., from about 40-75° C., or from about 50-65° C. In certain embodiments, temperatures approaching the boiling point of water (i.e., 100° C.) are avoided. Boiling conditions are not desirable for CIP equipment, particularly when strong acids are used, as the process becomes quite energy intensive, resulting in greater costs, and the combination of the acids and high temperatures can degrade rubber gaskets and seals used within the CIP equipment.

Preferably, the detergent composition used in the methods according to the present invention is a use solution that is formed by diluting a detergent concentrate as described herein. In particularly preferred embodiments, the detergent concentrate is diluted with water at a dilution ratio of parts water to parts detergent within the range of from about 99:1 to 10:1, from about 80:1 to about 20:1, or from about 60:1 to about 30:1. Most preferably, the dilution ratio is 49:1 (i.e., a 2% use solution).

The detergent composition may be introduced into the CIP apparatus in the form of a single concentrate formulation. However, it is also within the scope of the present invention for the detergent composition to be introduced into the CIP as a two-part system that is mixed within the CIP apparatus. In such embodiments, the first part of the two-part system comprises the nitric acid, and the second part of the two-part system comprises at least a portion of the at least one non-ionic surfactant and at least a portion of the at least one mineral acid other than nitric acid. In particular embodiments, the first part that contains the nitric acid may also comprise a portion of the at least one mineral acid other than nitric acid.

In certain embodiments of the present invention, the contacting step may be carried out for a period of time of less than 2 hours, less than 1.5 hours, or less than 1 hour. Alternatively, the contacting step is carried out for a period of about 10 minutes to 2 hours, about 15 minutes to 1.5 hours, or about 20 minutes to 1 hour. Most preferably, the contacting step is carried out for 40 minutes or less. This contact time is contrast with the contact times required to dissolve the mineral deposits, especially magnesium phosphate deposits, using the acid components alone or sequentially. As illustrated in the examples below, when the acids are used alone or sequentially, the time to achieve dissolution of the mineral deposits is 6 to 12 hours. Thus, it appears that an unexpected synergy is occurring when the two mineral acids are used simultaneously.

In certain embodiments, methods according to the present invention also may comprise a pre-rinse step, occurring prior to the introduction of the detergent composition, in which the CIP apparatus is flushed with water and/or a detergent pre-rinse solution to remove non-mineral deposit soils present within the apparatus. Also, the methods may comprise a post-rinse step, occurring after the step of contacting the surfaces of the CIP apparatus with the detergent composition and dissolving of the mineral deposits, in which the CIP apparatus again is flushed with water to remove detergent and soil residues from the apparatus in preparation for resuming use of the CIP apparatus.

### EXAMPLES

The following examples set forth preferred embodiments of compositions and methods of using the compositions to dissolve mineral deposits. It is to be understood, however, that these examples are provided by way of illustration and nothing therein should be taken as a limitation upon the overall scope of the invention.

### Example 1

In this example, the effectiveness of a detergent composition in dissolving a magnesium phosphate complex taken from CIP equipment used in the manufacture of a high-protein beverage. The equipment used brings in both liquid and powdered starting materials, blends those materials in mix tanks, and then sends the liquid finished product through a ultra-high temperature (UHT) unit, which directly injects steam to produce a product temperature of 127° C. (260° F.) for two seconds. The product is then sent through a flash tank that cools the mixture to 79° C. (175° F.), and then through a cooling press that cools the product to 27° C. (80° F.). Once cooled, the product is stored in an equalization/storage tank where it awaits packaging.

Samples of a magnesium phosphate complex was taken from the equalization/storage tank in the form of 2.5-3.8 cm (1-1.5 inch) crystals of a white to white gray substance. The crystals were crushed to an average size of 1.3 cm (0.5 in) in the long dimension. Two (2) grams of the crushed magnesium phosphate complex was added to 500 mL of tap water in a beaker. The magnesium phosphate dispersions were tested with both alkaline and acid products in combination with various surfactant and surfactant-containing products. Of all the products tested, only certain acid-based products were found to be capable of successfully dissolving the magnesium phosphate complex. In particular, these acid-based products are identified as Detergent A, which comprised 69.43% water, 21.00% phosphoric acid (75%), 4.72% of a nonionic surfactant (Plurafac® LF220), 4.00% methanesulfonic acid (70%), and 0.85% of a defoaming surfactant (e.g., Degressal® SD20), and a nitric/phosphoric acid mixture (hereafter the “Acid Mixture”), which comprised 40% nitric acid (˜65%), 10% phosphoric acid (75%), 0.1% urea, and 49.9% water.

The acid solutions were added to the beaker containing the crushed magnesium phosphate and mixed for 10 seconds. The beaker containing the detergent composition and magnesium phosphate complex was placed in a microwave oven, and the contents heated to approximately 65° C. (150° F.). The beaker was then removed from the microwave, and the contents mixed at medium speed with a paddle mixer at 340 rpm until the magnesium phosphate dissolved.

Table 3, below, summarizes the formulations tested and the results.

TABLE 3

| | Dose of | Dose of Acid | Initial | | Time to |
|---|---|---|---|---|---|
| Trial | Detergent A | Mixture | Temp., | | dissolve |
| No. | (wt. %) | (wt. %) | ° C. (° F.) | pH | (min) |
| 1 | 0.5 | 2 | 65 (150) | 1.5 | <30 |
| 2 | 0 | 2 | 63 (145) | 1.8 | 180 |
| 3 | 1 | 0 | 64 (148) | 2.2 | 360 |
| 4 | 1.5 | 0 | 62 (143) | 2.0 | 720 |

Results of the testing indicated that the best results were achieved through a combination of 0.5% Detergent A and 2.0% of Acid Mixture. This was the only program that dissolved the magnesium phosphate crystals in less than 30 minutes. The Acid Mixture alone was successful in dissolving the magnesium phosphate crystals, but it took approximately 3 hours, a time frame that is not commercially acceptable as the CIP equipment would have to be out of production for this entire period of time.

In addition, it was noted that Detergent A by itself worked the best when used at 1%, and performance diminished as the dose increased. However, performance of Detergent A by itself was considerably worse than the Acid Mixture by itself, requiring at least 6 hours to dissolve the magnesium phosphate crystals.

Based upon these results, an exemplary cleaning protocol was developed as follows. The CIP equipment undergoes a pre-rinse until the pre-rinse solution returns clear. The CIP equipment is then cleaned with a solution of 0.5% of Detergent A and 1.5-2% of the Acid Mixture (or an equivalent combined concentrate, see Table 1, above) at a temperature of less than 75° C. for 40 minutes. The CIP equipment undergoes a post-rinse to remove detergent residues. The CIP equipment may then be treated with an acid sanitizer (e.g., AcidiShine™ from DeLaval Cleaning Solutions) for 10 minutes. Finally, the system can be drained and is ready to be put back into production.

### Example 2

In this example, the efficacy of several detergent compositions in dissolving magnesium phosphate was studied. Three different formulations were prepared: (1) the mixture of Detergent A and the Acid Mixture from Trial No. 1 in Example 1; (2) a composition comprising only the acid components from Trial No. 1 in Example 1; and (3) a comparative formulation in which the ratio of nitric acid to phosphoric acid was approximately 1:1, and a relatively high concentration of methanesulfonic acid. The comparative example was a 1.5% v/v dilution of a concentrate comprising 14.67% by weight nitric acid, 14.71% by weight phosphoric acid, 21.43% by weight methane sulfonic acid, 1.00% by weight Plurafac® LF220, and the balance being water.

The same testing protocol as used in Example 1 was followed in this example. The total cleaning time for each trial was 25 minutes. Each trial was run twice. The results of these trials are provided in Table 4.

TABLE 4

| | Initial | Final | | Average % |
|---|---|---|---|---|
| | MgPO₄ | MgPO₄ | % MgPO₄ | MgPO₄ |
| Cleaning solution | weight (g) | weight (g) | removed | removed |
| 0.5% Detergent | 2.009 | 0 | 100 | 100 |
| A + 2.0% Acid | 2.037 | 0 | 100 | |
| Mixture | | | | |
| Acids only (1.1% | 2.059 | 1.193 | 42.040 | 40.407 |
| phosphoric, 2.0% | 2.073 | 1.269 | 38.775 | |
| nitric, 0.02% | | | | |
| methanesulfonic) | | | | |
| Comparative | 2.073 | 1.822 | 12.118 | 12.605 |
| formulation | 2.037 | 1.770 | 13.093 | |

The data shows that neither the acid-only formulation nor the comparative formulation exhibit the same cleaning efficacy as the mixture of Detergent A and the Acid Mixture. In addition, the data shows that the presence of the nonionic surfactant plays an important role in the cleaning efficacy, as does the ratio of the nitric and phosphoric acids, with best results achieved when nitric acid is the predominant mineral acid present.

1. A method of dissolving a mineral deposit on at least one surface of a clean-in-place apparatus comprising:
introducing into the clean-in-place system an aqueous detergent composition comprising nitric acid, at least one mineral acid other than nitric acid, at least one non-ionic surfactant; and
contacting the at least one surface of the clean-in-place apparatus comprising the mineral deposit with the detergent composition and dissolving the mineral deposit, the detergent composition having a temperature of from 30-90° C. during contact with the at least one surface.

2. The method of claim 1, wherein the mineral deposit predominantly comprises magnesium phosphate.

3. The method of claim 1, wherein the aqueous detergent composition comprises a use solution formed from a detergent concentrate.

4. The method of claim 3, wherein the detergent concentrate comprises:
from 1-40% by weight of nitric acid;
from 0.5-25% by weight of the at least one mineral acid other than nitric acid;
from 0.05-10% by weight of the at least one non-ionic surfactant; and
from 0-5% by weight of an alkyl sulfonic acid.

5. The method of claim 1, wherein the aqueous detergent composition comprises:
from 0.1-10% by weight of nitric acid;
from 0.01-5% by weight of the at least one mineral acid other than nitric acid;
from 0.005-2.5% by weight of the at least one non-ionic surfactant; and
from 0-2.5% by weight of an alkyl sulfonic acid.

6. The method of claim 1, wherein the at least one mineral acid other than nitric acid comprises a member selected from the group consisting of sulfuric acid, hydrochloric acid, perchloric acid, boric acid, phosphoric acid, hydrofluoric acid, hydrobromic acid, hydroiodic acid, and combinations thereof.

7. The method of claim 1, wherein the aqueous detergent composition comprises a two-part system that is mixed within the clean-in-place apparatus, wherein the first part of the two-part system comprises the nitric acid, and wherein the second part of the two-part system comprises at least a portion of the at least one non-ionic surfactant and at least a portion of the at least one mineral acid other than nitric acid.

8. The method of claim 1, wherein the contacting step is carried out for a period of time of less than 2 hours.

9. A detergent composition comprising:
from 1-40% by weight of nitric acid;
from 0.5-25% by weight of the at least one mineral acid other than nitric acid;
from 0.05-10% by weight of the at least one non-ionic surfactant; and
from 0-5% by weight of an alkyl sulfonic acid.

10. The detergent composition of claim 9, wherein the weight ratio of nitric acid to the at least one mineral acid other than nitric acid is from 3:1 to 20:1.

11. The detergent composition of claim 9, wherein the at least one mineral acid other than nitric acid comprises a member selected from the group consisting of sulfuric acid, hydrochloric acid, perchloric acid, boric acid, phosphoric acid, hydrofluoric acid, hydrobromic acid, hydroiodic acid, and combinations thereof.

12. The detergent composition of claim 9, wherein the at least one non-ionic surfactant comprises an alkyl alkoxylated alcohol or ether surfactant.

13. A detergent use solution comprising:
from 0.1-10% by weight of nitric acid;
from 0.01-5% by weight of the at least one mineral acid other than nitric acid;
from 0.005-2.5% by weight of the at least one non-ionic surfactant; and
from 0-2.5% by weight of an alkyl sulfonic acid.

14. The detergent use solution of claim 13, wherein the weight ratio of nitric acid to the at least one mineral acid other than nitric acid is from 3:1 to 20:1.

15. The detergent use solution of claim 13, wherein the nitric acid is present within the use solution at a level of from 0.5-5% by weight.

16. The detergent use solution of claim 13, wherein the at least one mineral acid other than nitric acid comprises a member selected from the group consisting of sulfuric acid, hydrochloric acid, perchloric acid, boric acid, phosphoric acid, hydrofluoric acid, hydrobromic acid, hydroiodic acid, and combinations thereof.
